(19) United States
(12) Patent Application Publication
(10) Pub. No.: US 2026/0304021 A1
(43) Pub. Date: Oct. 1, 2026

(54) EARPHONES

(71) Applicant: SHENZHEN SHOKZ CO., LTD., Shenzhen (CN)

(72) Inventors: Tao ZHAO, Shenzhen (CN); Peigeng TONG, Shenzhen (CN); Haochen LIU, Shenzhen (CN); Jiang XU, Shenzhen (CN); Lei ZHONG, Shenzhen (CN)

(73) Assignee: SHENZHEN SHOKZ CO., LTD., Shenzhen (CN)

(21) Appl. No.: 19/688,508

(22) Filed: May 26, 2026

Related U.S. Application Data
(63) Continuation of application No. 19/424,089, filed on Dec. 17, 2025.
Application No. 19/424,089 is a continuation of application No. PCT/CN2024/096710, filed on May 31, 2024.

(51) Int. Cl. H04R 1/10; H04R 1/08

(52) U.S. Cl. CPC H04R 1/1075; H04R 1/08; H04R 1/1008; H04R 1/105; H04R 2460/11

(57) ABSTRACT

The present disclosure provides an earphone including a sound generating unit, an abutment unit, and an ear hook. The ear hook has a symmetry plane along a length direction of the ear hook. The abutment unit includes a first housing and a first microphone. The sound generating unit includes a second housing and a second microphone. The earphone further includes a processing circuit configured to perform noise reduction processing based on a first sound and a second sound. The earphone further includes a first reference plane located below the symmetry plane and parallel to the symmetry plane in a wearing state. A distance from the first reference plane to the symmetry plane is less than or equal to 5 mm. A first sound inlet includes a sound inlet end located on an outer wall surface of the first housing.

### CROSS REFERENCE TO RELATED APPLICATIONS

This application is a Continuation of U.S. Patent Application No. 19/424,089 filed on Dec. 17, 2025, which is a continuation of International Application No. PCT/CN2024/096710 filed on May 31, 2024, the entire contents of which are incorporated herein by reference.

### TECHNICAL FIELD

The present disclosure generally relates to the technical field of electronic devices, and in particular, to an earphone.

### BACKGROUND

Earphones have been widely used in people’s daily lives and may be used with electronic devices such as a mobile phone and a computer to provide a sound playback function for a user. An ear-clip earphone, usually small in size, is a new type of earphone and may be used by being clipped to an auricle of a wearer. Further, as the ear-clip earphone does not block an ear canal, the ear-clip earphone not only ensures safety in outdoor scenarios but also provides better wearing comfort compared with an in-earphone.

However, sound reception effects of current ear-clip earphones are difficult to meet requirements.

### SUMMARY

One or more embodiments of the present disclosure provide an earphone. The earphone includes a sound generating unit, an abutment unit, and an ear hook. The ear hook connects the sound generating unit and the abutment unit. In a wearing state, the sound generating unit and the abutment unit form a clamping state on two sides of an auricle, and the sound generating unit is located in a concha cavity. The ear hook has a symmetry plane along a length direction of the ear hook. The abutment unit includes a first housing and a first microphone disposed in the first housing, the first microphone collecting a first sound via a first sound inlet on the first housing. The sound generating unit includes a second housing and a second microphone disposed in the second housing, the second microphone collecting a second sound via a second sound inlet on the second housing. The earphone further includes a processing circuit configured to perform noise reduction processing based on the first sound and the second sound. The earphone has a first reference plane located below the symmetry plane and parallel to the symmetry plane in the wearing state. A distance from the first reference plane to the symmetry plane is less than or equal to 5 mm. The first sound inlet includes a sound inlet end located on an outer wall surface of the first housing; and the sound inlet end is entirely located on a side of the first reference plane facing the symmetry plane.

In some embodiments, at least a portion of the sound inlet end of the first sound inlet is located on a side of the symmetry plane facing the first reference plane, and a maximum linear distance from a hole edge of the sound inlet end of the first sound inlet located on the side of the symmetry plane facing the first reference planes to the symmetry plane is less than or equal to 4 mm.

In some embodiments, the earphone is set to support a left ear wearing state and a right ear wearing state. A count of the first reference planes is two, and the two first reference planes are symmetrically disposed on two sides of the symmetry plane. One of the two first reference planes is located below the symmetry plane when the earphone is in the left ear wearing state, and the other one of the two first reference planes is located below the symmetry plane when the earphone is in the right ear wearing state. And the sound inlet end of the first sound inlet is entirely located between the two first reference planes.

In some embodiments, a count of the first sound inlets is two, the sound inlet ends of the two first sound inlets are arranged on two sides of the symmetry plane and are both entirely located between the two first reference planes.

In some embodiments, the sound inlet ends of the two first sound inlets are symmetrically arranged relative to the symmetry plane.

In some embodiments, a count of the first microphones is one. The first microphone collects the first sound via the two first sound inlets; the sound inlet ends of the two first sound inlets are spaced apart from each other; and the two first sound inlets are in communication with each other.

In some embodiments, the sound inlet end of the first sound inlet is entirely located on a side of the symmetry plane away from the first reference plane.

In some embodiments, a minimum linear distance from the hole edge of the sound inlet end of the first sound inlet to the symmetry plane is greater than or equal to 5 mm.

In some embodiments, the second sound inlet includes a sound inlet end located on an outer wall surface of the second housing, and a minimum linear distance between a hole edge of the sound inlet end of the second sound inlet and a hole edge of the sound inlet end of the first sound inlet is greater than or equal to 15 mm.

In some embodiments, along a width direction of the ear hook, the sound inlet end of the first sound inlet and the sound inlet end of the second sound inlet are at least partially overlapped with the ear hook, respectively.

In some embodiments, the first sound inlet has a first axial direction pointing to an outside of the first housing; the second sound inlet has a second axial direction pointing to an outside of the second housing; and an angle between an orthogonal projection of the first axial direction on the symmetry plane and an orthogonal projection of the second axial direction on the symmetry plane is greater than or equal to 115 degrees.

In some embodiments, the first housing includes a main body and a transition unit. The transition unit is disposed on an outer circumferential surface of the main body and is connected to the ear hook; the transition unit is arranged to be tapered in a direction away from the main body, to make the ear hook and the outer surface of the main body be connected smoothly; the first microphone is disposed in the transition unit; and the first sound inlet is disposed on the transition unit.

In some embodiments, the processing circuit is further configured to perform a wind noise detection based on the first sound and/or the second sound, and control the first microphone to be in an operating state and the second microphone to be in a non-operating state when a wind noise is detected to be greater than or equal to a preset threshold.

Beneficial effects of the present disclosure are as follows: by disposing the sound inlet end of the first sound inlet entirely located on the side of the first reference plane facing the symmetry plane, the position of the sound inlet end of the first sound inlet is limited. On one hand, the arrangement ensures that during the wearing state of the earphone, the sound inlet end of the first sound inlet is largely obstructed by the auricle of the user, while the second sound inlet disposed at the sound generating unit is closer to the mouth of the user and unobstructed, which enhances the difference in the sounds collected by the first sound inlet and the second sound inlet, thereby increasing the disparity between the first sound collected by the first microphone and the second sound collected by the second microphone. On the other hand, the arrangement ensures that the line connecting the first sound inlet and the second sound inlet points more directly towards the mouth, further amplifying the sound reception difference between the first microphone and the second microphone, which contributes to improving the noise reduction effect of the noise reduction processing performed by the processing circuit using the first sound and the second sound, enhances the sound reception effect of the earphone, and ultimately improves the user experience.

### BRIEF DESCRIPTION OF THE DRAWINGS

FIG. 1 is a schematic diagram illustrating a wearing state of an earphone on a human ear according to some embodiments of the present disclosure;

FIG. 2 is a front view of a structure of the earphone in FIG. 1 according to some embodiments of the present disclosure;

FIG. 3 is a perspective view of a structure of the earphone in FIG. 1 according to some embodiments of the present disclosure;

FIG. 4 is a top view of a structure of the earphone in FIG. 1 according to some embodiments of the present disclosure;

FIG. 5 is a top view of another structure of the earphone in FIG. 1 according to some embodiments of the present disclosure;

FIG. 6 is a schematic diagram illustrating a cross-sectional view of a structure of the earphone in FIG. 5 along section line V-V according to some embodiments of the present disclosure;

FIG. 7 is a schematic diagram illustrating an enlarged view of a local region Z of the earphone in FIG. 4 according to some embodiments of the present disclosure;

FIG. 8 is a top view of another structure of the earphone in FIG. 1 according to some embodiments of the present disclosure;

FIG. 9 is a schematic diagram illustrating a contour of a cross-section corresponding to section line V-V in FIG. 6 according to some embodiments of the present disclosure;

FIG. 10 is a top view of another structure of the earphone in FIG. 1 according to some embodiments of the present disclosure;

FIG. 11 is a top view of another structure of the earphone in FIG. 1 according to some embodiments of the present disclosure;

FIG. 12 is a perspective view of another structure of the earphone in FIG. 1 according to some embodiments of the present disclosure;

FIG. 13 is a schematic block diagram illustrating a circuit structure of the earphone in FIG. 1 according to some embodiments of the present disclosure;

FIG. 14 is a front view of a structure of a sound generating unit in FIG. 2 according to some embodiments of the present disclosure;

FIG. 15 is a schematic diagram illustrating a cross-sectional view of a structure of a sound generating unit in FIG. 11 along section line A-A according to some embodiments of the present disclosure; and

FIG. 16 is schematic diagram illustrating a cross-sectional view of another structure of the earphone in FIG. 5 along section line V-V according to some embodiments of the present disclosure.

### DETAILED DESCRIPTION

The present disclosure is further described in detail below through specific embodiments in conjunction with the accompanying drawings. Similar components in different embodiments are denoted by associated similar reference numerals. In the following embodiments, many details are described to facilitate a better understanding of the present disclosure. However, those skilled in the art may readily recognize that some features may be omitted under different circumstances, or may be replaced by other elements, materials, or manners. In some instances, certain operations relevant to the present disclosure are not shown or described to avoid obscuring the core aspects of the disclosure. For those skilled in the art, a detailed description of the relevant operations is not necessary, as those skilled in the art may fully understand the relevant operations based on the descriptions herein and general technical knowledge in the art.

Furthermore, the characteristics, operations, or features described in the present disclosure may be combined in any suitable manner to form various embodiments. Simultaneously, the steps or actions in the method descriptions may also be sequentially exchanged or adjusted in a manner obvious to those skilled in the art. Therefore, the various sequences in the present disclosure and drawings are only for clearly describing a particular embodiment and do not imply a mandatory sequence, unless it is explicitly stated that a specific sequence must be followed.

The serial numbers assigned to components herein, such as “first”, “second”, etc., are used only to distinguish the described objects and carry no sequential or technical meaning. The terms “connect” and “couple” as used in the present disclosure, unless otherwise specified, include both direct and indirect connections (couplings).

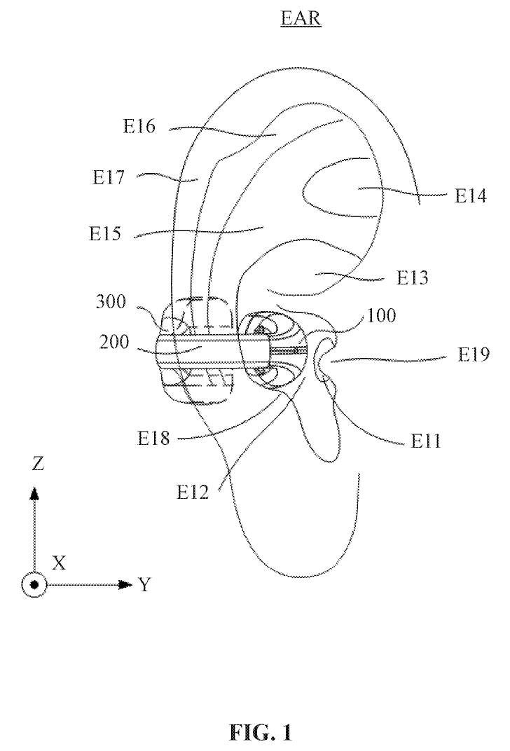

As shown in FIG. 1, an ear of a user may include physiological parts such as an ear canal E11, a concha cavity E12, a cymba conchae E13, a triangular fossa E14, an antihelix E15, a scaphoid fossa E16, an auricle E17, and an antitragus E18. Although the ear canal E11 has a certain depth and extends to an eardrum of the ear, for ease of description and in conjunction with FIG. 1, unless otherwise specified, the ear canal E11 specifically refers to an entrance (i.e., an ear hole) facing away from the eardrum. Furthermore, physiological parts such as the concha cavity E12, the cymba conchae E13, and the triangular fossa E14 have a certain volume and depth. The concha cavity E12 is directly connected to the ear canal E11, that is, it can be simply considered as that the aforementioned ear hole is located at a bottom of the concha cavity E12.

Furthermore, the ear also has a tragus E19 around a periphery of the ear canal. Compared with parts such as the concha cavity E12, the cymba conchae E13, and the triangular fossa E14, which have a certain depth and volume in three-dimensional space (i.e., the parts are recessed towards a rear side of the ear along a direction approaching a head of the user), the tragus E19 protrudes towards a front side of the ear along a direction away from the head of the user. The front side of the ear is a concept relative to the rear side of the ear. The former refers to a side of the ear facing away from the head, for example, as shown in FIG. 1, the latter refers to a side of the ear facing towards the head, both are defined with respect to the ear of the user.

Furthermore, individual differences may exist among different users, leading to variations in the shape, size, and other dimensions of the ear. For ease of description and to reduce (or even eliminate) individual differences among different users, a simulator including a head and (left, right) ears may be manufactured based on ANSI: S3.36, S3.25 and IEC:603187 standards, for example, a GRAS45BCKEMAR. Therefore, descriptions such as “a user wears the earphone,” “the earphone is in a wearing state,” and “in the wearing state” may refer to the earphone described in the present disclosure being worn on the ear of the aforementioned simulator. Certainly, precisely because individual differences exist among different users, there may be some differences between a situation when the earphone is worn by different users and a situation when the earphone is worn on the ear of the aforementioned simulator. However, such differences should be tolerable.

It should be noted that in fields such as medicine and anatomy, three fundamental planes including a sagittal plane, a coronal plane, and a horizontal plane, and three fundamental axes including a sagittal axis, a coronal axis, and a vertical axis may be defined for the human body. The sagittal plane refers to a plane perpendicular to the ground along an anteroposterior direction of the body, dividing the body into a left part and a right part. The coronal plane refers to a plane perpendicular to the ground along a mediolateral direction of the body, dividing the body into an anterior part and a posterior part. The horizontal plane refers to a plane parallel to the ground along a superior-inferior direction of the body, dividing the body into an upper part and a lower part. Correspondingly, the sagittal axis refers to an axis along the anteroposterior direction of the body and perpendicular to the coronal plane. The coronal axis refers to an axis along the mediolateral direction of the body and perpendicular to the sagittal plane. The vertical axis refers to an axis along the superior-inferior direction of the body and perpendicular to the horizontal plane. Furthermore, the front side of the ear described in the present disclosure is a concept relative to the rear side of the ear. The former refers to a side of the ear facing away from the head, the latter refers to a side of the ear facing towards the head, both are defined with respect to the ear of the user. Observing the ear of the aforementioned simulator along the direction of the human coronal axis yields a front outline schematic of the ear shown in FIG. 1. Accordingly, and in conjunction with FIG. 1, three directions X, Y, and Z may be simply regarded as a human coronal axis, a human sagittal axis, and a human vertical axis, respectively. Three planes XY, XZ, and YZ may be simply regarded as a human horizontal plane, a human coronal plane, and a human sagittal plane, respectively.

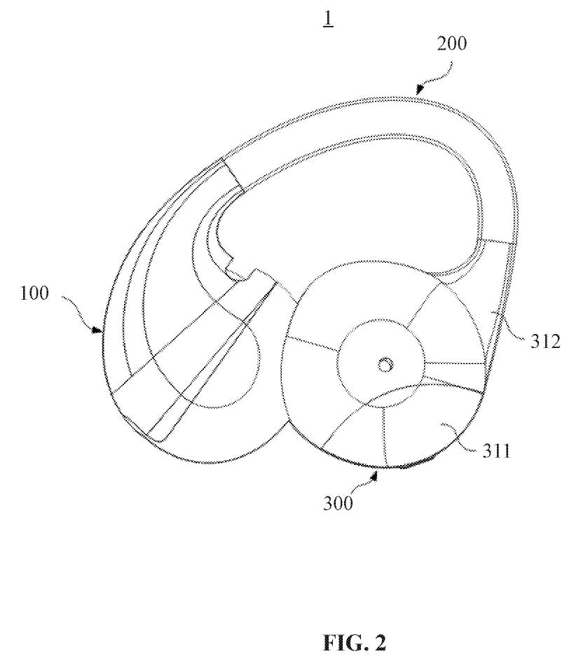

Embodiments of the present disclosure describe at least one exemplary structure of an earphone 1. As shown in FIG. 1, FIG. 1 illustrates a state where the earphone 1 is worn on the ear of the user. The earphone 1 may be an ear-clip earphone. As shown in FIGS. 1-3, the earphone 1 includes a sound generating unit 100 for inserting into the concha cavity E12 of the user, an abutment unit 300 for abutting behind the ear of the user, and an ear hook 200 connecting the sound generating unit 100 and the abutment unit 300. In the wearing state, the ear hook 200 may extend around the auricle E17 of the user, the sound generating unit 100 and the abutment unit 300 form a clamping state on opposite sides of the auricle E17 of the user, and the sound generating unit 100 is located in the concha cavity E12. The sound generating unit 100 is a sound playback device configured to convert electrical signals into sound signals and play the sound signals to a wearer. The abutment unit 300 and the sound generating unit 100 form the clamping state to clamp the entire earphone 1 onto the ear of the user. In some embodiments, components such as a battery and a circuit board may be disposed within the abutment unit 300. The abutment unit 300 may also be used without a battery installed, with the battery installed in the sound generating unit 100.

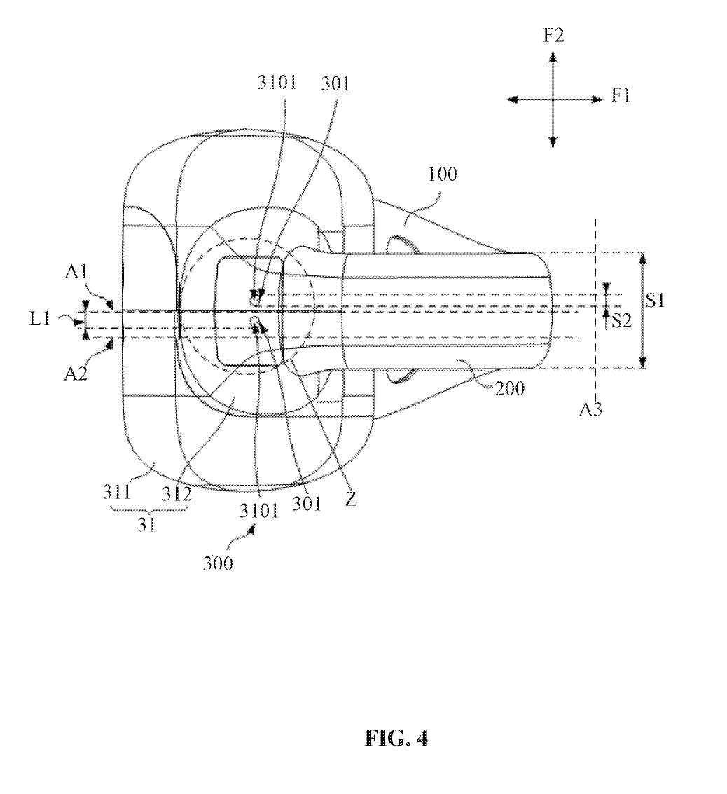

In some embodiments, as shown in FIG. 4, the ear hook 200 has a symmetry plane A1 disposed along a length direction F1 of the ear hook 200. Specifically, the symmetry plane A1 of the ear hook 200 is disposed along the length direction F1 of the ear hook 200, and a difference between portions of the ear hook 200 located at two sides of the symmetry plane A1 is minimal or no difference exits. That is, if the ear hook 200 is regularly symmetrical, the portions of the ear hook 200 located at two sides of the symmetry plane A1 are identical. If the ear hook 200 is not strictly symmetrical, the difference between the portions of the ear hook 200 located at two sides of the symmetry plane A1 should be the smallest among all possible dividing manners. For example, the difference may be distinguished by observing a projection of the ear hook 200 on a plane perpendicular to the symmetry plane A1.

Optionally, as shown in FIGS. 4, 5, and 6, the abutment unit 300 includes a first housing 31 and a first microphone 32 disposed in the first housing 31. The first microphone 32 collects a first sound via a first sound inlet 3101 on the first housing 31. The sound generating unit 100 includes a second housing 11 and a second microphone 12 disposed in the second housing 11. The second microphone 12 collects a second sound via a second sound inlet 1101 on the second housing 11. The earphone 1 further includes a processing circuit 400 configured to perform noise reduction processing based on the first sound and the second sound. The earphone 1 also has a first reference plane A2 located below the symmetry plane A1 and parallel to the symmetry plane A1 in the wearing state. A distance from the first reference plane A2 to the symmetry plane A1 is less than or equal to 5 mm. For example, the distance may be 1 mm, 2 mm, 2.5 mm, 3 mm, 3.5 mm, 4 mm, 4.5 mm, etc. Certainly, other numerical values are also possible. The first sound inlet 3101 includes a sound inlet end 301 located on an outer wall surface of the first housing 31. An external sound is introduced into the first sound inlet 3101 from the sound inlet end 301 and transmitted to the first microphone 32 via the first sound inlet 3101. The sound inlet end 301 of the first sound inlet 3101 is entirely located on a side of the first reference plane A2 facing the symmetry plane A1.

The processing circuit 400 may perform the noise reduction processing based on the first sound and the second sound. For example, by disposing the first sound inlet 3101 and the second sound inlet 1101 at different positions, the sounds introduced by the two sound inlets may have certain differences. Consequently, the sounds collected by the first microphone 32 and the second microphone 12 may have different signal amplitudes in a primary reception frequency band (e.g., a human voice frequency band). Accordingly, the processing circuit 400 may identify and eliminate noise using the first sound and the second sound.

By disposing the sound inlet end 301 of the first sound inlet 3101 entirely located on the side of the first reference plane A2 facing the symmetry plane A1, the position of the sound inlet end 301 of the first sound inlet 3101 is limited. On one hand, the arrangement ensures that during the wearing state of the earphone 1, the sound inlet end 301 of the first sound inlet 3101 is largely obstructed by the auricle E17 of the user, while the second sound inlet 1101 disposed at the sound generating unit 100 is closer to the mouth of the user and unobstructed, which enhances the difference in the sounds collected by the first sound inlet 3101 and the second sound inlet 1101, thereby increasing the disparity between the first sound collected by the first microphone 32 and the second sound collected by the second microphone 12, and improving the noise reduction effect of the noise reduction processing performed by the processing circuit using the first sound and the second sound. On the other hand, the arrangement ensures that the line connecting the first sound inlet 3101 and the second sound inlet 1101 points more directly towards the mouth, which enhances the sound reception effect of the earphone 1, and ultimately improves the user experience.

Optionally, as shown in FIG. 4, at least a portion of the sound inlet end 301 of the first sound inlet 3101 is located on a side of the symmetry plane A1 facing the first reference plane A2, and a maximum linear distance L1 from a hole edge of the sound inlet end 301 of the first sound inlet 3101 located on the side of the symmetry plane A1 facing the first reference plane A2 to the symmetry plane A1 is less than or equal to 4 mm. For example, the distance may be 0.5 mm, 1 mm, 2 mm, 2.5 mm, 3 mm, 3.5 mm, etc. Certainly, other values are also possible.

Referring to FIG. 1, since the auricle E17 of the user is entirely in a convex arc shape, and an upper portion along the human vertical axis is more convex than a lower portion, in the wearing state, the higher the sound inlet end 301 of the first sound inlet 3101 is disposed, the greater the occlusion degree of the convex auricle E17 of the user to the first sound inlet 3101 may be, and the greater the difference between the first sound collected by the first microphone 32 and the second sound collected by the second microphone 12 may be, which is more conducive to improving the noise reduction effect.

By arranging the maximum linear distance L1 from the hole edge of the sound inlet end 301 of the first sound inlet 3101 located on the side of the symmetry plane A1 facing the first reference plane A2 to the symmetry plane A1 to be less than or equal to 4 mm, the convex auricle E17 of the user can better obstruct the first sound inlet 3101 in the wearing state. Furthermore, the arrangement ensures that the line connecting the first sound inlet 3101 and the second sound inlet 1101 points more directly towards the mouth, which is beneficial for increasing the difference between the first sound collected by the first microphone 32 and the second sound collected by the second microphone 12.

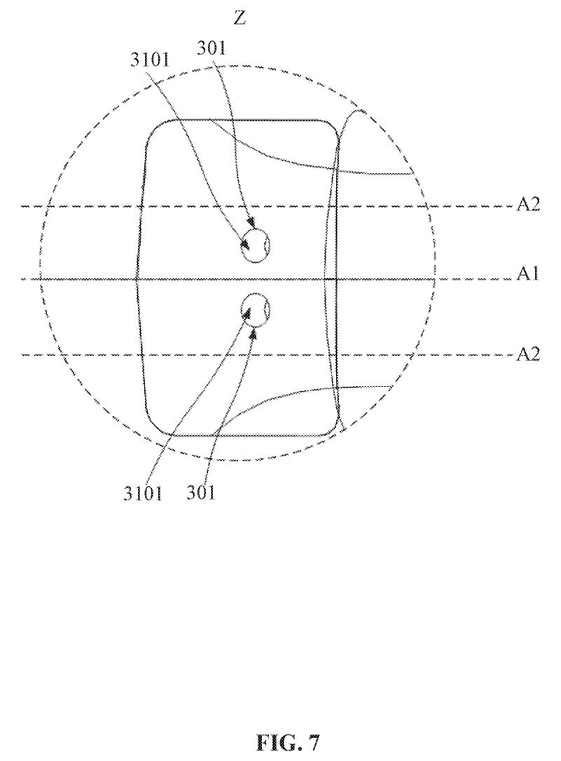

Optionally, as shown in FIG. 7, the earphone 1 is set to support a left ear wearing state and a right ear wearing state. That is, the earphone 1 may be worn on a left ear or on a right ear of the user. A count of the first reference planes A2 is two, and the two first reference planes A2 are symmetrically disposed on two sides of the symmetry plane A1. One of the two first reference planes A2 is located below the symmetry plane A1 when the earphone 1 is in the left ear wearing state, and the other one of the two first reference planes A2 is located below the symmetry plane A1 when the earphone 1 is in the right ear wearing state. And the sound inlet end 301 of the first sound inlet 3101 is entirely located between the two first reference planes A2.

The earphone 1 is configured not to be limited to be worn on either the left ear or the right ear, and is instead configured to be worn on either the left ear or the right ear, which means that when the user switches the earphone 1 from the left ear wearing state to the right ear wearing state, or from the right ear wearing state to the left ear wearing state, the state of the earphone 1 relative to the ear remains unchanged. That is, an orientation of a sound outlet 1102 and an orientation of a pressure relief hole 1103 on the earphone 1 relative to the ear canal E11 remains unchanged, and the visual appearance when worn on either ear is identical. Furthermore, the earphone 1 may automatically identify which ear it is worn on and adopt a corresponding control logic and change functions of the earphone 1 based on the worn ear, such as the selection of left or right audio channels or the switching of touch control functions. By arranging the sound inlet end 301 of the first sound inlet 3101 entirely between the two first reference planes A2, the sound inlet end 301 of the first sound inlet 3101 can be largely obstructed by the auricle E17 of the user regardless of whether the earphone 1 is worn on the left ear or the right ear. Furthermore, the line connecting the first sound inlet 3101 and the second sound inlet 1101 points more directly towards the mouth. The arrangement enables the earphone 1 to achieve good noise reduction effects in both the left ear wearing state and the right ear wearing state, which is beneficial for improving sound reception effect of the earphone 1, and helps to enhance consistency of the earphone 1 between the left ear wearing state and the right ear wearing state, thereby improving user experience.

Optionally, as shown in FIG. 7, a count of the first sound inlets 3101 is two, the sound inlet ends 301 of the two first sound inlets 3101 are arranged on two sides of the symmetry plane A1 and are both entirely located between the two first reference planes A2. When the earphone 1 is worn on the left ear or the right ear, positions of the first sound inlets 3101 relative to the ear are close to each other, or even essentially the same, making the earphone 1 to realize a relatively close noise reduction effect when switched between the left ear and the right ear, which is conducive to improving the sound reception effect of the earphone 1, and is conducive to improving the user experience.

Optionally, as shown in FIG. 7, the sound inlet ends 301 of the two first sound inlets 3101 are symmetrically arranged relative to the symmetry plane A1, which enables the earphone 1 to achieve identical noise reduction effects when switched between the left ear and the right ear. Additionally, the symmetrical arrangement helps to improve aesthetic appearance.

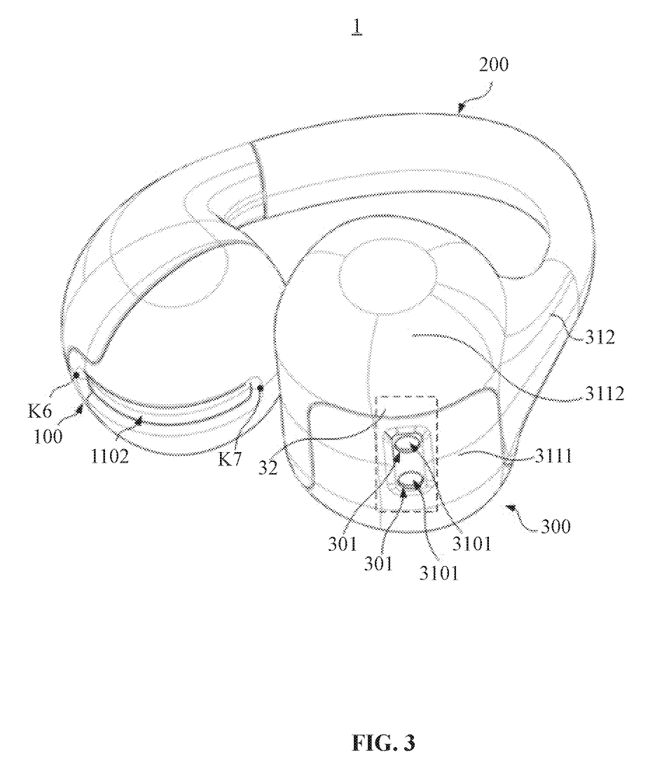

Optionally, as shown in FIGS. 3 or 4, a count of the first microphone 32 is one. The first microphone 32 collects the first sound through the two first sound inlets 3101, the sound inlet ends 301 of the two first sound inlets 3101 are spaced apart from each other, and the two first sound inlets 3101 are in communication with each other. The two first sound inlets 3101 in communication with each other are beneficial for maintaining air pressure balance. In some embodiments, airflow may enter through one of the two first sound inlets 3101 and exit through the other one of the two first sound inlet 3101, thereby helping to reduce wind noise in the first sound collected by the first microphone 32. The arrangement is structurally simple and saves installation space.

In some embodiments, the count of the first sound inlet 3101 may also be one, and the symmetry plane A1 passes through the first sound inlet 3101. In this way, the earphone 1 may achieve identical noise reduction effects whether worn on the left ear or the right ear. In this case, whether worn on the left ear or the right ear, the sound inlet end 301 of the first sound inlet 3101 may be substantially obstructed by the auricle E17 of the user. Furthermore, the line connecting the first sound inlet 3101 and the second sound inlet 1101 points more directly towards the mouth, which is beneficial for improving the noise reduction effect, enhancing the sound reception effect of the earphone 1, and improving the user experience.

Furthermore, in some embodiments, the count of the first microphones 32 may also be two, and each of the two first microphones 32 corresponds to one first sound inlet 3101. The present disclosure does not limit the aspect, and those skilled in the art can make a selection according to actual needs.

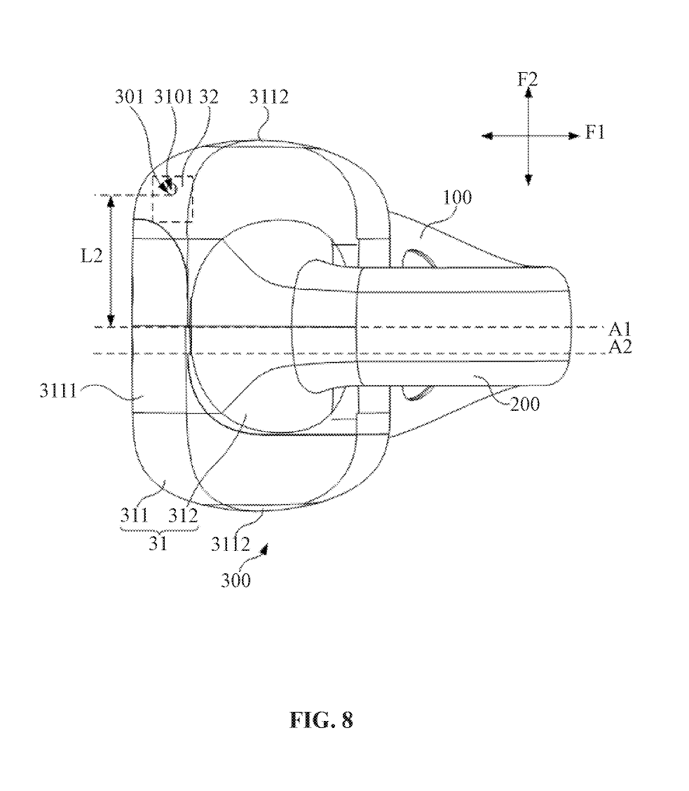

Optionally, as shown in FIG. 8, the earphone 1 may be set to support only the left ear wearing state or only the right ear wearing state, and the sound inlet end 301 of the first sound inlet 3101 is entirely located on a side of the symmetry plane A1 away from the first reference plane A2. The arrangement enhances an occlusion effect of the auricle E17 of the user on the sound inlet end 301 of the first sound inlet 3101 when the earphone 1 is in the wearing state, and also makes the line connecting the first sound inlet 3101 and the second sound inlet 1101 point more directly towards the mouth, which is beneficial for increasing a degree of a difference between sounds introduced by the first sound inlet 3101 and the second sound inlet 1101, thereby improving the effect of the noise reduction processing of the earphone 1.

Optionally, as shown in FIG. 8, a minimum linear distance L2 from the hole edge of the sound inlet end 301 of the first sound inlet 3101 to the symmetry plane A1 is greater than or equal to 5 mm. For example, the minimum linear distance L2 may be 5.5 mm, 6 mm, 6.5 mm, 7 mm, etc. Certainly, the minimum linear distance L2 may also be other values. When the two first sound inlets 3101 in communication with each other are provided, the minimum linear distance L2 refers to a minimum linear distance from the hole edge of the first sound inlet 3101 closer to the symmetry plane A1 to the symmetry plane A1. Alternatively, the minimum linear distance L2 refers to a smaller one of minimum linear distances from the hole edges of the two first sound inlets 3101 to the symmetry plane A1, respectively.

By setting the minimum linear distance L2 from the hole edge of the sound inlet end 301 of the first sound inlet 3101 to the symmetry plane A1 to be greater than or equal to 5 mm, the sound inlet end 301 of the first sound inlet 3101 is substantially distanced from the symmetry plane A1, which helps to enhance the occlusion effect of the auricle E17 of the user on the sound inlet end 301 of the first sound inlet 3101 when the earphone 1 is in the wearing state. The arrangement makes the line connecting the first sound inlet 3101 and the second sound inlet 1101 point more directly towards the mouth, which is beneficial for improving the noise reduction processing effect of the earphone 1.

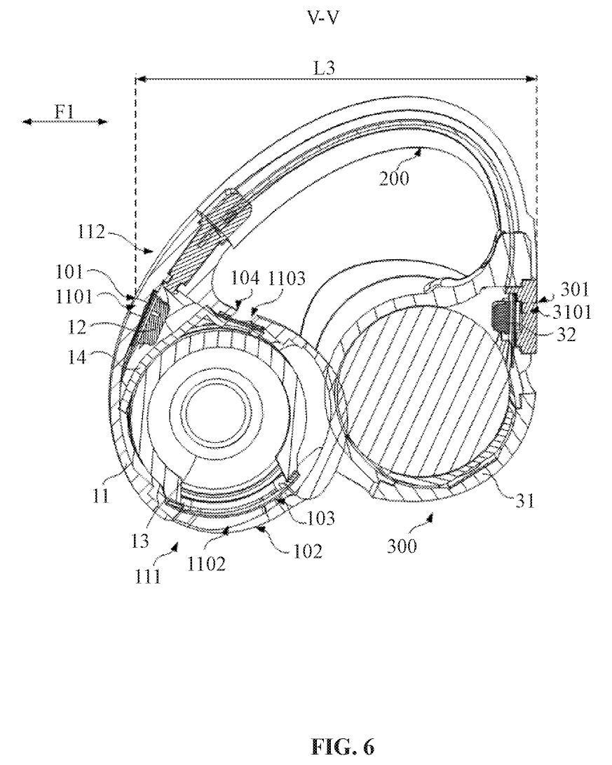

Optionally, as shown in FIG. 8, the first housing 31 includes a main body 311, and the main body 311 includes a peripheral side wall 3111 and two oppositely arranged end walls 3112. The peripheral side wall 3111 is configured to contact a back side of the auricle E17. The first sound inlet 3101 may also be arranged on the peripheral side wall 3111 and located on a side of the peripheral side wall 3111 away from the sound generating unit 100. In some embodiments, the first sound inlets 3101 may be arranged on the end walls 3112. The present disclosure does not limit the aspect, and those skilled in the art can make a selection according to actual needs. Optionally, as shown in FIG. 6, the second sound inlet 1101 includes a sound inlet end 101 located on an outer wall surface of the second housing 11, and a minimum linear distance L3 between a hole edge of the sound inlet end 101 of the second sound inlet 1101 and the hole edge of the sound inlet end 301 of the first sound inlet 3101 is greater than or equal to 15 mm. For example, the minimum linear distance L3 be 15 mm, 18 mm, 20 mm, 30 mm, etc. Certainly, the minimum linear distance L3 may also be other values.

By setting the minimum linear distance L3 between the hole edge of the sound inlet end 101 of the second sound inlet 1101 and the hole edge of the sound inlet end 301 of the first sound inlet 3101 to be greater than or equal to 15 mm, a difference between the first sound collected by the first microphone 32 and the second sound collected by the second microphone 12 is increased, which is beneficial for improving the noise reduction effect when the processing circuit 400 performs the noise reduction processing using the first sound and the second sound. The arrangement is also beneficial for improving the sound reception effect of the earphone 1 and enhancing the user experience.

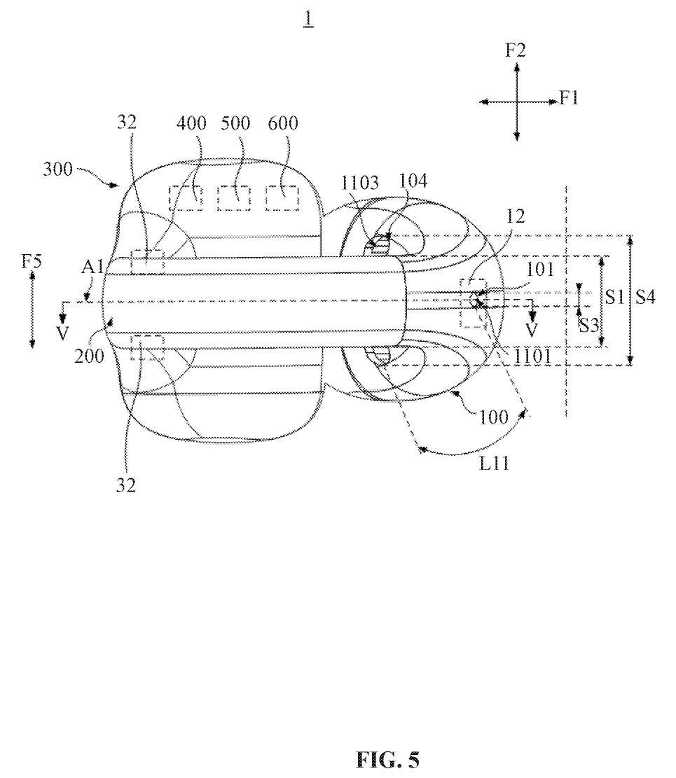

Optionally, as shown in FIGS. 4 and 5, along a width direction F2 of the ear hook 200, the sound inlet end 301 of the first sound inlet 3101 and the sound inlet end 101 of the second sound inlet 1101 are at least partially overlapped with the ear hook 200.

In some embodiments, the symmetry plane A1 is perpendicular to the width direction F2 of the ear hook 200. Taking a straight-line perpendicular to the symmetry plane A1 and parallel to the width direction F2 of the ear hook 200 as a reference line A3, when the ear hook 200 is projected onto the reference line A3 along the symmetry plane A1, it has a first projection width S1. When the sound inlet end 301 of the first sound inlet 3101 is projected onto the reference line A3 along the symmetry plane A1, it has a second projection width S2. When the sound inlet end 101 of the second sound inlet 1101 is projected onto the reference line A3 along the symmetry plane A1, it has a third projection width S3. The second projection width S2 and the third projection width S3 are at least partially overlapped with the first projection width S1, respectively, which facilitates the ear hook 200 to form a barrier between the sound inlet end 301 of the first sound inlet 3101 and the sound inlet end 101 of the second sound inlet 1101. Consequently, the difference between the first sound collected by the first microphone 32 and the second sound collected by the second microphone 12 is increased, which is beneficial for improving the effect of the noise reduction processing of the earphone 1.

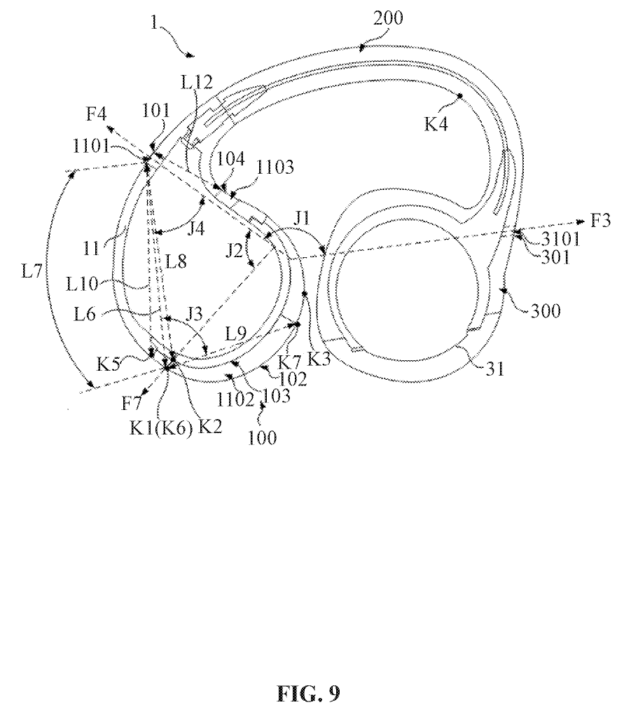

Optionally, as shown in FIG. 9, the first sound inlet 3101 has a first axial direction F3 pointing to an outside of the first housing 31, the second sound inlet 1101 has a second axial direction F4 pointing to an outside of the second housing 11, and an angle J1 between an orthogonal projection of the first axial direction F3 on the symmetry plane A1 and an orthogonal projection of the second axial direction F4 on the symmetry plane A1 is greater than or equal to 115 degrees. For example, the angle J1 may be 115 degrees, 120 degrees, 125 degrees, 130 degrees, etc. Certainly, the angle J1 may also be other values.

The first axial direction F3 of the first sound inlet 3101 may be determined specifically by the following manner: when a reference cylinder matching a size of the first sound inlet 3101 is inserted through the first sound inlet 3101, an axial direction of the reference cylinder is the first axial direction F3 of the first sound inlet 3101. It should be noted that “matching the size” described here means that the reference cylinder can just be inserted through the first sound inlet 3101 and is not easy to fall out from it.

A manner for determining the second axial direction F4 of the second sound inlet 1101 may refer to the determination of the first axial direction F3 of the first sound inlet 3101, and details are not repeated here.

By setting the angle J1 between the orthogonal projection of the first axial direction F3 on the symmetry plane A1 and the orthogonal projection of the second axial direction F4 on the symmetry plane A1 to be greater than or equal to 115 degrees, orientations of the first sound inlet 3101 and the second sound inlet 1101 have a certain difference. Consequently, sounds introduced by the first sound inlet 3101 and the second sound inlet 1101 also have a certain difference, further increasing the difference between the first sound collected by the first microphone 32 and the second sound collected by the second microphone 12, which is beneficial for improving the effect of the noise reduction processing of the earphone 1.

Optionally, as shown in FIGS. 4 and 8, the first housing 31 includes the main body 311 and a transition unit 312. The transition unit 312 is disposed on an outer peripheral surface of the main body 311 and is connected to the ear hook 200. The transition unit 312 is arranged to be tapered in a direction away from the main body 311, to make the ear hook 200 and the outer surface of the main body 311 be connected smoothly. The first microphone 32 is disposed in the transition unit 312, and the first sound inlet 3101 is disposed on the transition unit 312, to make full use of space in the transition unit 312, which is beneficial for improving space utilization of the earphone 1 and making the structure of the earphone 1 more compact.

Optionally, the processing circuit 400 is further configured to perform a wind noise detection based the first sound and/or the second sound, and control the first microphone 32 to be in an operating state and the second microphone 12 to be in a non-operating state when a wind noise is detected to be greater than or equal to a preset threshold. The operating state refers to a state in which the microphone is turned on and the sound collected by the microphone is used by the processing circuit 400. The non-operating state refers to a state in which the microphone is turned off, or the microphone is turned on but the sound collected by the microphone is not used by the processing circuit 400.

The processing circuit 400 performing the wind noise detection based on the first sound and/or the second sound means that the processing circuit 400 identifies sound signal features in the first sound and/or the second sound to determine whether features of a wind noise signal exist therein, thereby detecting whether the wind noise exists and an intensity of the wind noise.

Since the sound inlet end 301 of the first sound inlet 3101 is substantially obstructed by the auricle E17 of the user in the wearing state, while the sound inlet end 101 of the second sound inlet 1101 is not obstructed, a wind noise in the sound introduced by the second sound inlet 1101 may be greater than a wind noise in the sound introduced by the first sound inlet 3101. Therefore, when the processing circuit 400 detects that the wind noise is greater than or equal to the preset threshold, the processing circuit 400 controls the first microphone 32 to be in the operating state and controls the second microphone 12 to be in the non-operating state, which avoids the second microphone 12 collecting a sound with an excessive wind noise, which would affect the sound reception effect of the earphone 1, and is beneficial for improving the user experience.

In some embodiments, as shown in FIG. 5, the abutment unit 300 includes two first microphones 32. The two first microphones 32 are configured to collect the first sound, respectively. The sound generating unit 100 includes the second microphone 12. The second microphone 12 is configured to collect the second sound. The earphone 1 further includes a detection element 500 and the processing circuit 400. The detection element 500 is configured to detect a relative positional relationship between the two first microphones 32 in the wearing state. The relative positional relationship refers to a relative up-down relationship between the two first microphones 32 along a gravity direction F5 in the wearing state. The processing circuit 400 controls, based on a detection result of the detection element 500, one of the two first microphones 32 that is relatively upper along the gravity direction F5 to be in the operating state, and controls the other one that is relatively lower along the gravity direction F5 to be in the non-operating state. Furthermore, the processing circuit 400 performs the noise reduction processing based on the first sound collected by the first microphone 32 in the operating state and the second sound collected by the second microphone 12.

The operating state refers to a state in which the microphone is turned on and the sound collected by the microphone is used by the processing circuit 400. The non-operating state refers to a state in which the microphone is turned off, or the microphone is turned on but the sound collected by the microphone is not used by the processing circuit 400.

On one hand, when the earphone 1 is in the wearing state, the higher the position of the first microphone 32, the more easily it is obstructed by the auricle E17, resulting in a greater difference in sound reception between the first microphone 32 and the second microphone 12. On the other hand, when the earphone 1 is in the wearing state, the higher the position of the first microphone 32, the better the line connecting the first microphone 32 and the second microphone 12 points towards the mouth, which also results in a greater difference in sound reception between the first microphone 32 and the second microphone 12. Therefore, by providing the two first microphones 32, regardless of whether the earphone 1 is worn on the left ear or the right ear in the wearing state, the one of the two first microphones 32 that is relatively upper along the gravity direction F5 is always in the operating state, which is beneficial for increasing the difference between the first sound collected by the first microphone 32 and the second sound collected by the second microphone 12, and improving the effect of the noise reduction processing of the earphone 1. The arrangement ensures the sound reception effect of the earphone 1 while enabling a left-right ear switching function of the earphone 1, thereby improving the user experience.

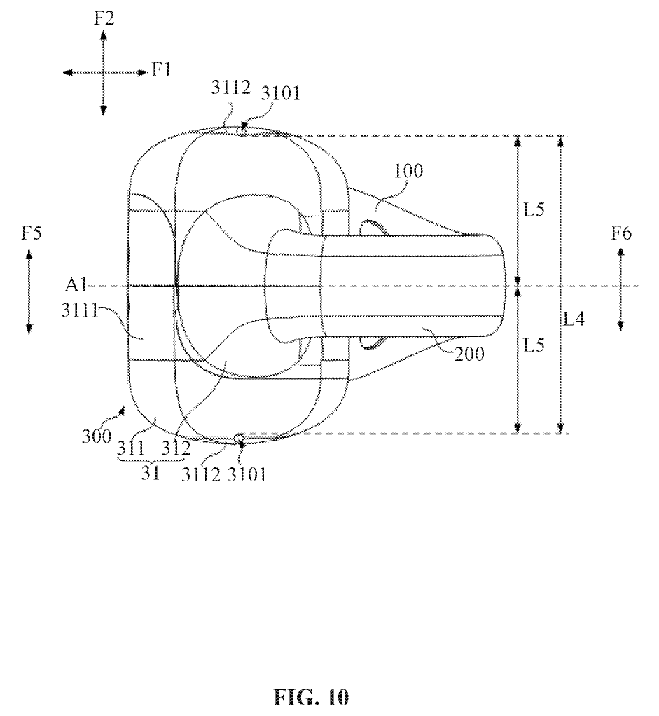

Optionally, as shown in FIG. 10, the ear hook 200 has the symmetry plane A1 along the length direction F1 of the ear hook 200. The abutment unit 300 further includes the first housing 31. Two first sound inlets 3101 are arranged on the first housing 31. Each first microphone 32 collects the first sound through a corresponding one of the two first sound inlets 3101. The two first sound inlets 3101 respectively include the sound inlet ends 301 located on the outer wall surface of the first housing 31. The sound inlet ends 301 of the two first sound inlets 3101 are arranged on two sides of the symmetry plane A1.

By arranging the corresponding first sound inlet 3101 for each of the two first microphones 32, and arranging the sound inlet ends 301 of the two first sound inlets 3101 on the two sides of the symmetry plane A1, when the first microphone 32 that is relatively upper along the gravity direction F5 (i.e., the first microphone 32 located above the symmetry plane A1) is in the operating state, the sound inlet end 301 of the first sound inlet 3101 corresponding to the first microphone 32 is also located above the symmetry plane A1. In this way, regardless of whether the earphone 1 is worn on the left ear or the right ear, the auricle E17 of the user may substantially obstruct the first microphone 32 in the operating state. Furthermore, the arrangement makes the line connecting the first microphone 32 in the operating state and the second microphone 12 point more directly towards the mouth. Consequently, the difference between the first sound collected by the first microphone 32 and the second sound collected by the second microphone 12 is increased, improving the effect of the noise reduction processing of the earphone 1. The arrangement also ensures the sound reception effect of the earphone 1 while enabling the left-right ear switching function, thereby improving the user experience.

Optionally, as shown in FIG. 10, the sound inlet ends 301 of the two first sound inlets 3101 are symmetrically arranged relative to the symmetry plane A1, which allows the two first sound inlets 3101 to achieve the same sound introduction effect during the process of switching the earphone 1 between the left ear and the right ear. Consequently, the earphone 1 can achieve a good effect of the noise reduction processing whether worn on the left ear or the right ear, and it is beneficial for improving the aesthetic appearance of the earphone 1.

Optionally, as shown in FIG. 10, the first housing 31 includes the main body 311. The main body 311 includes the peripheral side wall 3111 and the two oppositely arranged end walls 3112. The peripheral side wall 3111 is configured to contact the back side of the auricle E17. The two first sound inlets 3101 are respectively arranged on the two end walls 3112 of the abutment unit 300. The arrangement further enhances the occlusion effect of the auricle E17 of the user on the first sound inlet 3101 corresponding to the first microphone 32 in the operating state in the wearing state, and also makes the line connecting the first microphone 32 in the operating state and the second microphone 12 point better towards the mouth. Consequently, the difference between the first sound and the second sound is effectively increased, which is beneficial for the processing circuit 400 to achieve the good effect of the noise reduction processing.

Optionally, as shown in FIG. 10, in a direction F6 perpendicular to the symmetry plane A1, a minimum linear distance L4 between hole edges of the sound inlet ends 301 of the two first sound inlets 3101 is greater than or equal to 10 mm. For example, the minimum linear distance L4 may be 11 mm, 12 mm, 13 mm, 15 mm, 18 mm, 20 mm, etc. Certainly, the minimum linear distance L4 may also be other values.

By arranging the minimum linear distance L4 between the hole edges of the sound inlet ends 301 of the two first sound inlets 3101 to be greater than or equal to 10 mm, a certain distance is maintained between the two first sound inlets 3101. Thus, when the earphone 1 is in the wearing state, the first sound inlet 3101 corresponding to the first microphone 32 in the operating state may be better obstructed by the auricle E17 of the user. Furthermore, the line connecting the first microphone 32 in the operating state and the second microphone 12 may point better towards the mouth, which is beneficial for increasing the difference between the sounds collected by the first microphone 32 and the second microphone 12, thereby improving the effect of the noise reduction processing of the earphone 1.

Optionally, as shown in FIG. 10, minimum linear distances L5 from the hole edges of the sound inlet ends 301 of the two first sound inlets 3101 to the symmetry plane A1 are both greater than or equal to 5 mm. For example, the minimum linear distances L5 may be 5.5 mm, 6 mm, 8 mm, 10 mm, 15 mm, etc. Certainly, the minimum linear distances L5 may also be other values.

By arranging the minimum linear distances L5 from the hole edges of the sound inlet ends 301 of the two first sound inlets 3101 to the symmetry plane A1 to be both greater than or equal to 5 mm, a certain distance between the sound inlet ends 301 of the two first sound inlets 3101 and the symmetry plane A1 is maintained. Thus, when the earphone 1 is in the wearing state, the first sound inlet 3101 corresponding to the first microphone 32 in the operating state may be better obstructed by the auricle E17 of the user, which is beneficial for increasing the difference between the sounds collected by the first microphone 32 and the second microphone 12. Furthermore, the line connecting the first microphone 32 in the operating state and the second microphone 12 may point better towards the mouth, improving the effect of the noise reduction processing of the earphone 1.

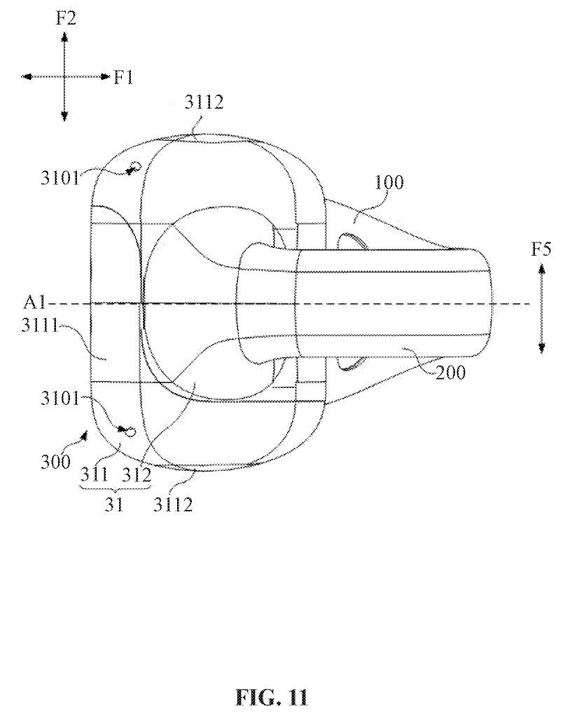

Optionally, as shown in FIG. 11, the two first sound inlets 3101 are both arranged on the peripheral side wall 3111 of the abutment unit 300 and are located on a side of the peripheral side wall 3111 away from the sound generating unit 100.

Since at least one of the two end walls 3112 of the abutment unit 300 is provided with an antenna for wireless radio frequency connection of the earphone 1 and/or a touch region for touch operation by a user, if the first sound inlets 3101 are arranged on the end walls 3112, it may cause mutual interference between the antenna and/or the touch region and the first sound inlet. Therefore, by arranging the first sound inlets 3101 on the peripheral side wall 3111, a possibility of mutual interference between the first sound inlets 3101 and the antenna and/or the touch region is effectively reduced, which is beneficial for improving stability and reliability of the earphone 1.

Optionally, the processing circuit 400 is configured to perform the wind noise detection based on the first sound and/or the second sound, control one of the two first microphones 32 that collects a first sound with a smaller wind noise to be in the operating state when a wind noise is detected to be greater than or equal to a preset threshold, and control the other one of the two first microphones 32 to be in the non-operating state when the wind noise is detected to be greater than or equal to the preset threshold. The arrangement allows the earphone 1 to obtain the first sound with a relatively smaller wind noise, which is beneficial for achieving good sound reception effect of the earphone 1 and improving the user experience.

Optionally, the processing circuit 400 is further configured to perform the wind noise detection based on the first sound and/or the second sound, control one of the two first microphones 32 that is relatively lower along the gravity direction F5 to be in the operating state, and control the second microphone 12 to be in the non-operating state, when the wind noise is detected to be greater than or equal to the preset threshold.

Since the sound inlet end 301 of the first sound inlet 3101 is substantially obstructed by the auricle E17 of the user in the wearing state, while the sound generating unit 100 is located in the concha cavity E12 and is not obstructed, the wind noise in the sound collected by the second microphone 12 may be greater than the wind noise in the sound collected by the first microphone 32. Therefore, when the wind noise greater than or equal to the preset threshold is detected, the processing circuit 400 may control the second microphone 12 to be in the non-operating state and one of the two first microphones 32 to be in the operating state. Furthermore, since the sound inlet end 301 of the first sound inlet 3101 corresponding to the first microphone 32 that is relatively lower along the gravity direction F5 is closer to the mouth of the user, in some embodiments, only the relatively lower first microphone 32 is set to be in the operating state. The first sound collected by the first microphone 32 may, while having a lower wind noise, collect the voice emitted by the user as clearly and completely as possible, which is beneficial for achieving the good sound reception effect of the earphone 1 and improving the user experience.

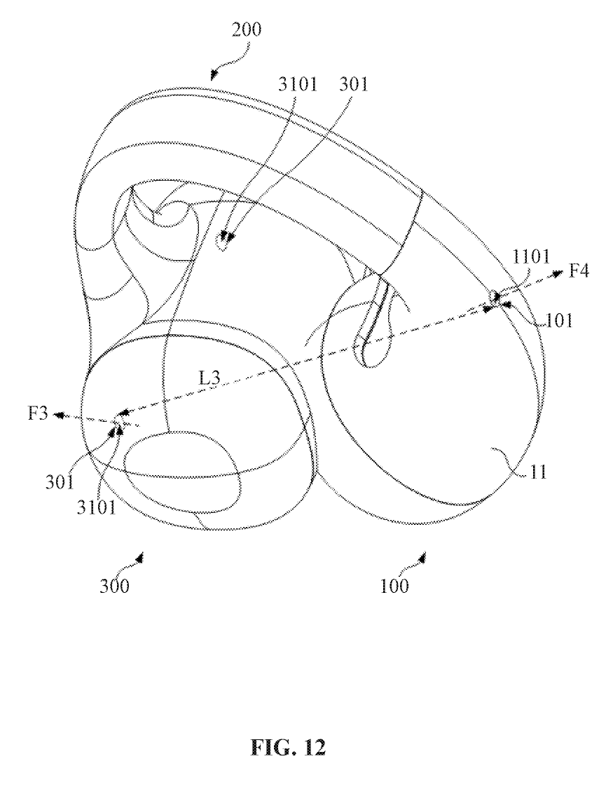

Optionally, as shown in FIG. 12, the sound generating unit 100 includes the second housing 11. The second sound inlet 1101 is arranged on the second housing 11. The second microphone 12 collects the second sound via the second sound inlet 1101. The second sound inlet 1101 includes the sound inlet end 101 located on the outer wall surface of the second housing 11. The minimum linear distance L3 between the hole edge of the sound inlet end 301 of the first sound inlet 3101 and the hole edge of the sound inlet end 101 of the second sound inlet 1101 is greater than or equal to 15 mm. For example, the minimum linear distance L3 may be 15 mm, 17 mm, 20 mm, 25 mm, etc. Certainly, the minimum linear distance L3 may also be other values.

By setting the minimum linear distance L3 between the hole edge of the sound inlet end 301 of the first sound inlet 3101 and the hole edge of the sound inlet end 101 of the second sound inlet 1101 to be greater than or equal to 15 mm, a certain difference between the sounds introduced by the first sound inlet 3101 and the second sound inlet 1101 is ensured, which is beneficial for the processing circuit 400 to perform the good noise reduction processing and improves the effect of the noise reduction processing of the earphone 1.

Optionally, as shown in FIG. 12, the first sound inlet 3101 has the first axial direction F3 pointing to the outside of the first housing 31, the second sound inlet 1101 has the second axial direction F4 pointing to the outside of the second housing 11, and the angle between the orthogonal projection of the first axial direction F3 on the symmetry plane A1 and the orthogonal projection of the second axial direction F4 on the symmetry plane A1 is greater than or equal to 115 degrees. For example, the angle may be 115 degrees, 120 degrees, 125 degrees, 130 degrees, etc. Certainly, the angle may also be other values.

In the embodiment, the manners for determining the first axial direction F3 of the first sound inlet 3101 and the second axial direction F4 of the second sound inlet 1101 may be the same as or similar to those in the foregoing embodiments, and details are not described herein.

By arranging the angle between the orthogonal projection of the first axial direction F3 on the symmetry plane A1 and the orthogonal projection of the second axial direction F4 on the symmetry plane A1 to be greater than or equal to 115 degrees, the first sound inlet 3101 and the second sound inlet 1101 face different directions. The arrangement ensures a certain difference between the sounds introduced by the first sound inlet 3101 and the second sound inlet 1101, effectively improves the difference between the first sound and the second sound, and is beneficial for improving the effect of the noise reduction processing of the earphone 1.

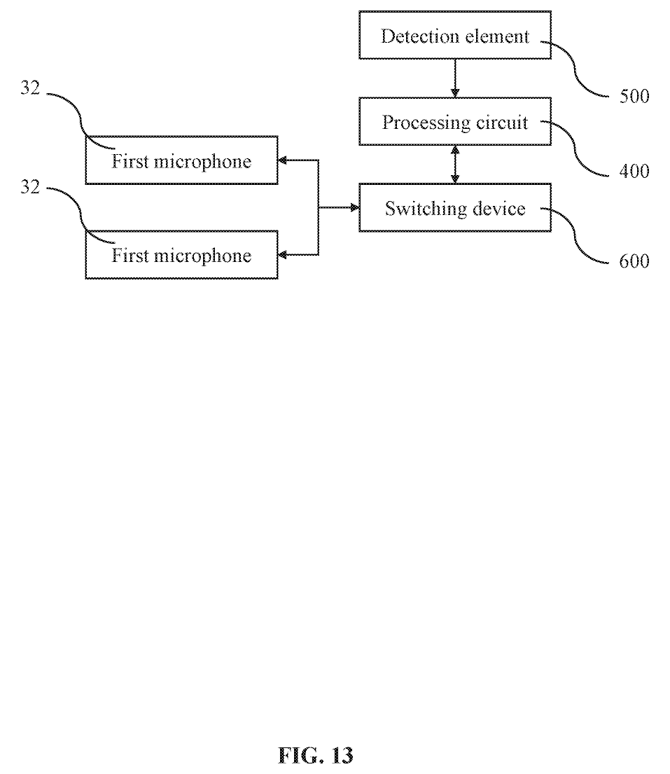

Optionally, as shown in FIGS. 5 and 13, the earphone 1 further includes a switching device 600. The two first microphones 32 are connected to a same audio port of the processing circuit 400 via the switching device 600. Based on the detection result of the detection element 500, the processing circuit 400 controls one of the two first microphones 32 that is relatively higher along the gravity direction F5 to be connected to the processing circuit 400 to be in the operating state, and disconnect the other one of the two first microphones 32 that is relatively lower along the gravity direction F5 from the processing circuit 400 to be in the non-operating state.

By providing the switching device 600, the processing circuit 400 can conveniently perform switching control on the two first microphones 32 based on the detection result of the detection element 500, which is beneficial for improving switching efficiency and reliability of the earphone 1.

In some embodiments, switching of the two first microphones 32 may also be implemented only by software, which is within the understanding of those skilled in the art, and details are not described herein.

In some embodiments, as shown in FIGS. 6 and 9, the sound generating unit 100 includes a housing, and a microphone and a sound generating assembly 13 disposed in the housing. The housing may be the foregoing second housing 11, and the microphone may be the foregoing second microphone 12. The sound inlet and the sound outlet 1102 are disposed on the second housing 11. The sound inlet may be the foregoing second sound inlet 1101. The second microphone 12 is configured to collect an external sound via the second sound inlet 1101. A sound generated by the sound generating assembly 13 is transmitted outward via the sound outlet 1102. The second sound inlet 1101 may be configured to introduce a sound to the second microphone 12. The second microphone 12 may be configured to collect the introduced sound. The second sound inlet 1101 includes the sound inlet end 101 located on the outer wall surface of the second housing 11. The sound outlet 1102 includes a first sound outlet end 102 located on the outer wall surface of the second housing 11. As shown in FIG. 9, a first shortest straight-line segment L6 is between the hole edge of the sound inlet end 101 of the second sound inlet 1101 and a hole edge of the first sound outlet end 102. A length of the first shortest straight-line segment L6 is greater than or equal to 9 mm. For example, the length may be 9 mm, 10 mm, 12 mm, 15 mm, etc. Certainly, the length may also be other values.

Since sound propagation follows an inverse square law, that is, an intensity of a sound is inversely proportional to a square of a distance from a sound source, the greater the distance from the sound source, the lower the intensity of the sound. By setting the length of the first shortest straight-line segment L6 to be greater than or equal to 9 mm, the sound transmitted outward from the sound outlet 1102 is effectively prevented from being introduced by the second sound inlet 1101, thereby avoiding interference with sound collection by the second microphone 12. The arrangement effectively reduces a possibility of echo when the user uses the earphone 1 for a call, and is beneficial for improving a call experience of the user.

Optionally, as shown in FIG. 9, along the outer wall surface of the second housing 11, a shortest wall connection line having common endpoints with the first shortest straight-line segment L6 is between the hole edge of the sound inlet end 101 of the second sound inlet 1101 and the hole edge of the first sound outlet end 102. The shortest wall connection line is referred to as a first shortest wall connection line L7. The first shortest wall connection line L7 is specifically a shortest arc segment formed by an outline of the outer wall surface of the second housing 11 between the hole edge of the sound inlet end 101 of the second sound inlet 1101 and the hole edge of the first sound outlet end 102. The first shortest wall connection line L7 is configured to protrude toward the outside of the second housing 11. A length of the first shortest wall connection line L7 is greater than or equal to 13 mm. For example, the length may be 13 mm, 15 mm, 18 mm, 20 mm, etc. Certainly, the length may also be other values.

By setting the length of the first shortest wall connection line L7 to be greater than or equal to 13 mm, the isolation effect of the second housing 11 between the second sound inlet 1101 and the sound outlet 1102 on the sound is improved, thereby reducing a possibility that the sound transmitted outward from the sound outlet 1102 interferes with sound collection by the second microphone 12.

Optionally, a ratio of the length of the first shortest wall connection line L7 to the length of the first shortest straight-line segment L6 is between 0.5 and 0.75. For example, the ratio may be 0.55, 0.65, 0.7, etc. Certainly, the ratio may also be other values.

By setting the ratio of the length of the first shortest wall connection line L7 to the length of the first shortest straight-line segment L6 to be between 0.5 and 0.75, the isolation effect of the second housing 11 between the second sound inlet 1101 and the sound outlet 1102 on the sound is further improved, which is beneficial for improving the sound reception effect of the earphone 1.

Optionally, as shown in FIGS. 5 and 6, the ear hook 200 has the symmetry plane A1 along the length direction F1 of the ear hook 200. The symmetry plane A1 passes through the sound inlet end 101 of the second sound inlet 1101 and the first sound outlet end 102. In the wearing state, the sound inlet end 101 of the second sound inlet 1101 is located on a side of the second housing 11 away from the auricle E17 and is closer to the ear hook 200 than the first sound outlet end 102.

By arranging the sound inlet end 101 of the second sound inlet 1101 and the first sound outlet end 102 to intersect with the symmetry plane A1, on one hand, an appearance of the earphone 1 is more symmetrical, on the other hand, the earphone 1 may be adapted for wearing on both the left ear and the right ear, which is beneficial for realizing the left-right ear switching function and effectively improves adaptability of the earphone 1.

Additionally, the sound inlet end 101 of the second sound inlet 1101 is arranged to be located on the side of the second housing 11 away from the auricle E17 in the wearing state, to make the second sound inlet 1101 better introduce speech emitted from a mouth of a user, thereby effectively improving the applicability of the earphone 1. In the wearing state, the sound inlet end 101 of the second sound inlet 1101 is closer to the ear hook 200 than the first sound outlet end 102, which makes the sound inlet end 101 avoid the sound generating assembly 13 and allows the sound generating assembly 13 to occupy a relatively large space, improving space utilization inside the second housing 11. In the wearing state, the first sound outlet end 102 of the sound outlet 1102 may be closer to an ear canal than the sound inlet end 101 of the second sound inlet 1101, making that the sound transmitted outward from the first sound outlet end 102 by the sound generating assembly 13 is more easily transmitted into the ear canal of the user.

Optionally, as shown in FIG. 9, the second sound inlet 1101 has an axial direction pointing to the outside of the second housing 11. The axial direction is referred to as the second axial direction F4. The sound outlet 1102 includes a second sound outlet end 103 located on an inner wall surface of the second housing 11. That is, the sound generated by the sound generating assembly 13 is transmitted to the outside of the earphone 1 sequentially through the second sound outlet end 103 and the first sound outlet end 102. A second shortest straight-line segment L8 is between the hole edge of the sound inlet end 101 of the second sound inlet 1101 and a hole edge of the second sound outlet end 103. An endpoint of the first shortest straight-line segment L6 on the hole edge of the first sound outlet end 102 is taken as a first reference point K1. An endpoint of the second shortest straight-line segment L8 on the hole edge of the second sound outlet end 103 is taken as a second reference point K2. The sound outlet 1102 has a reference direction F7 pointing from the second reference point K2 to the first reference point K1. An angle J2 between the orthogonal projection of the second axial direction F4 on the symmetry plane A1 and an orthogonal projection of the reference direction F7 on the symmetry plane A1 is greater than or equal to 70 degrees. For example, the angle J2 may be 70 degrees, 75 degrees, 80 degrees, 90 degrees, etc. Certainly, the angle J2 may also be other values.

By setting the angle J2 between the orthogonal projection of the second axial direction F4 on the symmetry plane A1 and the orthogonal projection of the reference direction F7 on the symmetry plane A1 to be greater than or equal to 70 degrees, the second sound inlet 1101 and the sound outlet 1102 have different orientations. The setting effectively reduces the possibility that the sound transmitted from the sound outlet 1102 is introduced by the second sound inlet 1101, effectively reduces the possibility that the sound generated by the sound generating assembly 13 interferes with the sound collection by the second microphone 12, and effectively reduces the possibility of echo when the user uses the earphone 1 for a call, which is beneficial for improving the call experience of the user.

Optionally, as shown in FIG. 3, the first sound outlet end 102 is arranged in a strip shape. On the symmetry plane A1, the hole edge of the first sound outlet end 102 has a first endpoint K6 and a second endpoint K7 spaced apart along a length direction of the first sound outlet end 102. The first endpoint K6 is closer to the sound inlet end 101 of the second sound inlet 1101 than the second endpoint K7.

By setting the first sound outlet end 102 in the strip shape, the area of the sound outlet 1102 is ensured. Meanwhile, when the earphone 1 is worn by the user, the second housing 11 and the concha cavity E12 of the ear of the user are not completely attached, leaving a space that gradually enlarges from the contact region between the second housing 11 and the ear towards an ear canal entrance, forming a wedge-like space. Consequently, a horn-like structure is formed between the sound outlet 1102 and the concha cavity E12. Utilizing the concha cavity E12 as a reflective wall creates enhanced sound wave reflection. Thus, the sound output from the sound outlet 1102 is reflected and amplified within the concha cavity E12, leveraging the reflective effect to increase the sound pressure at the ear canal entrance, which enables the user to perceive sound at a higher intensity and effectively improves the user experience.

Optionally, as shown in FIGS. 5 and 9, the first sound outlet end 102 and the sound inlet end 101 of the second sound inlet 1101 are symmetrically arranged relative to the symmetry plane A1, respectively. The first shortest straight-line segment L6 connects the first endpoint K6 and a position point on the hole edge of the sound inlet end 101 of the second sound inlet 1101 that is closest to the first endpoint K6. The earphone 1 further has a third shortest straight-line segment L9 connecting the first endpoint K6 and the second endpoint K7. An angle J3 between the first shortest straight-line segment L6 and the third shortest straight-line segment L9 is less than or equal to 75 degrees. For example, the angle J3 may be 60 degrees, 65 degrees, 70 degrees, 75 degrees, etc. Certainly, the angle J3 may also be other values.

By setting the angle J3 between the first shortest straight-line segment L6 and the third shortest straight-line segment L9 to be less than or equal to 75 degrees, an orientation of the sound outlet 1102 relative to the second sound inlet 1101 is further restricted. The setting effectively reduces the possibility that the sound transmitted from the sound outlet 1102 is introduced by the second sound inlet 1101, which is beneficial for improving the sound reception effect of the earphone 1.

Optionally, a length of the third shortest straight-line segment L9 is greater than or equal to 7 mm. For example, the length may be 7 mm, 10 mm, 13 mm, 15 mm, etc. Certainly, the length may also be other values.

By setting the length of the third shortest straight-line segment L9 to be greater than or equal to 7 mm, a size of the sound outlet 1102 better conforms to sizes and shapes of the concha cavity E12 and the ear canal, making it easier to form the horn-like structure that enhances the sound. The setting effectively improves the sound output effect of the earphone 1, effectively increases the sound pressure at the ear canal, and effectively increases the listening volume.

Optionally, as shown in FIG. 9, the second sound inlet 1101 has the axial direction pointing to the outside of the second housing 11. The axial direction is referred to as the second axial direction F4. An angle J4 between the second axial direction F4 and the first shortest straight-line segment L6 is greater than or equal to 40 degrees. For example, the angle J4 may be 40 degrees, 45 degrees, 50 degrees, 55 degrees, etc. Certainly, the angle J4 may also be other values.

By setting the angle J4 between the second axial direction F4 and the first shortest straight-line segment L6 to be greater than or equal to 40 degrees, the orientation of the second sound inlet 1101 relative to the sound outlet 1102 is further restricted. The setting effectively reduces the possibility that the sound transmitted from the sound outlet 1102 is introduced by the second sound inlet 1101, which is beneficial for improving the sound reception effect of the earphone 1.

Optionally, as shown in FIG. 9, on the symmetry plane A1, the outer wall surface of the second housing 11 has a third reference point K3 that is closest to the abutment unit 300. An inner contour of the ear hook 200 has a fourth reference point K4 in a region near an edge of the auricle in the wearing state, and the fourth reference point K4 is farthest from the third reference point K3. The outer wall surface of the second housing 11 further has a fifth reference point K5 that is farthest from the fourth reference point K4. The first sound outlet end 102 and the sound inlet end 101 of the second sound inlet 1101 are located on two sides of the fifth reference point K5.

In a natural state, an outer wall surface of the sound generating unit 100 and an outer wall surface of the abutment unit 300 are not in contact with each other, and the outer wall surface of the sound generating unit 100 and the outer wall surface of the abutment unit 300 have positions where a distance therebetween is shortest. An endpoint of a connecting line between the positions with the shortest distance, which is located on the outer wall surface of the second housing 11, is the third reference point K3. In the natural state, if the outer wall surface of the sound generating unit 100 and the outer wall surface of the abutment unit 300 are in contact with each other, a length of a shortest connecting line between the outer wall surface of the sound generating unit 100 and the outer wall surface of the abutment unit 300 is nearly 0. In this case, the third reference point K3 should be a midpoint of an arc line formed by a contact region where the outer wall surface of the sound generating unit 100 and the outer wall surface of the abutment unit 300 contact each other.

In the wearing state, the symmetry plane A1 is nearly parallel to a human horizontal plane. Within the symmetry plane A1, the ear hook 200, the sound generating unit 100, and the abutment unit 300 have an inner contour. The inner contour includes at least the fourth reference point K4. The fourth reference point K4 refers to a reference point on the inner contour that has a largest distance from the third reference point K3. In the wearing state, the fourth reference point K4 is a reference point located on the inner contour of the ear hook 200 and corresponding to the edge of the auricle E17 (e.g., a topmost or outermost edge of the auricle E17). The fourth reference point K4 may be an inflection point of the inner contour. For example, the inner contour is an overall contour line protruding away from the auricle E17. A curvature radius of a portion of the inner contour near a region of the edge of the auricle E17 first increases, then decreases, and then increases again starting from the fourth reference point K4 and extending toward the sound generating unit 100 and the abutment unit 300, respectively. The fifth reference point K5 refers to a position point on the sound generating unit 100 that is farthest from the fourth reference point K4.

By setting the first sound outlet end 102 and the sound inlet end 101 of the second sound inlet 1101 on two sides of the fifth reference point K5, the second housing 11 protruding between the first sound outlet end 102 and the sound inlet end 101 of the second sound inlet 1101 can isolate the sound transmitted from the first sound outlet end 102. The setting effectively reduces the possibility that the sound transmitted from the first sound outlet end 102 is introduced by the second sound inlet 1101, which is beneficial for improving the sound reception effect of the earphone 1.

Optionally, as shown in FIG. 9, a fourth shortest straight-line segment L10 is between the hole edge of the sound inlet end 101 of the second sound inlet 1101 and the fifth reference point K5. A ratio of a length of the fourth shortest straight-line segment L10 to the length of the first shortest straight-line segment L6 is between 0.71 and 0.96. For example, the ratio may be 0.75, 0.80, 0.85, 0.90, 0.95, etc. Certainly, the ratio may also be other values.

By setting the ratio of the length of the fourth shortest straight-line segment L10 to the length of the first shortest straight-line segment L6 to be between 0.71 and 0.96, the position of the sound inlet end 101 of the second sound inlet 1101 relative to the fifth reference point K5 is reasonably set, reducing the possibility that the sound transmitted from the sound outlet 1102 is introduced by the second sound inlet 1101, which is beneficial for improving the sound reception effect of the earphone 1.

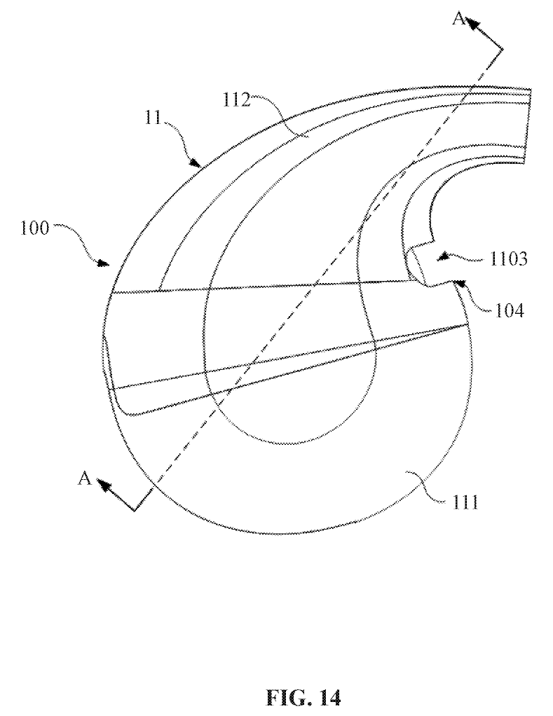

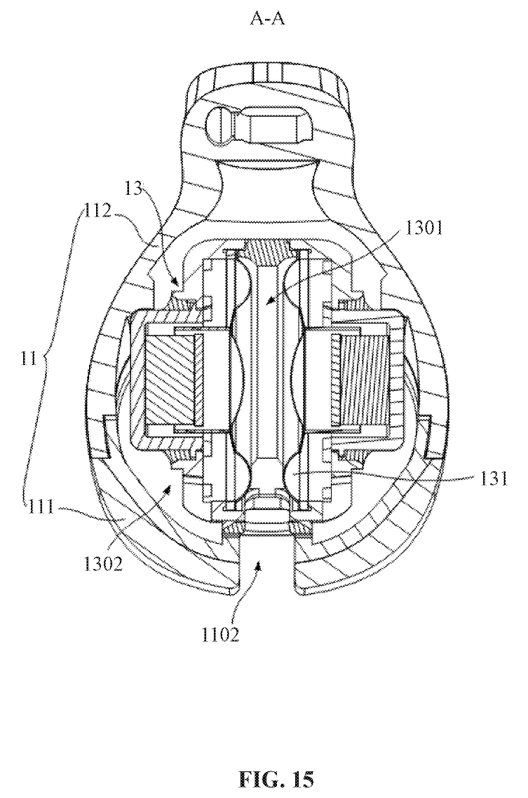

In some embodiments, as shown in FIGS. 14 and 15, the sound generating unit 100 includes the housing, and the microphone and the sound generating assembly 13 disposed in the housing. The housing may be the foregoing second housing 11. The microphone may be the foregoing second microphone 12. The sound generating assembly 13 includes at least one diaphragm 131. The sound generating assembly 13 cooperates with the second housing 11 to form the first acoustic cavity 1301 and the second acoustic cavity 1302 located on the two sides of the diaphragm 131. The sound inlet, the sound outlet 1102, and the pressure relief hole 1103 are disposed on the second housing 11. The sound inlet may be the foregoing second sound inlet 1101. The second microphone 12 is configured to collect the external sound via the second sound inlet 1101. The sound in the first acoustic cavity 1301 is transmitted to the ear canal of the user via the sound outlet 1102. The sound in the second acoustic cavity 1302 is transmitted to the outside of the second housing 11 via the pressure relief hole 1103. In some embodiments, the first acoustic cavity 1301 is a place where the diaphragm 131 vibrates to push air to form a sound wave for the user to listen to. The second acoustic cavity 1302 communicates with the pressure relief hole 1103 and further communicates with the external environment, and is used to balance an internal air pressure of the second housing 11. The second sound inlet 1101 and the pressure relief hole 1103 are arranged adjacent to the ear hook 200, respectively. The sound outlet 1102 is arranged farther from the ear hook 200 than the second sound inlet 1101 and the pressure relief hole 1103. The second sound inlet 1101 has the sound inlet end 101 located on the outer wall surface of the second housing 11. The pressure relief hole 1103 includes a sound outlet end 104 located on the outer wall surface of the second housing 11. A shortest straight-line segment, referred to as a fifth shortest straight-line segment L12, is between the hole edge of the sound inlet end 101 of the second sound inlet 1101 and a hole edge of the sound outlet end 104 of the pressure relief hole 1103. A length of the fifth shortest straight-line segment L12 is less than or equal to 4 mm. For example, the length may be 1 mm, 2 mm, 3 mm, 3.5 mm, etc. Certainly, the length may also be other values. The ear hook 200 is further configured to block the sound from the pressure relief hole 1103 from being transmitted toward the second sound inlet 1101.

By arranging the second sound inlet 1101 and the pressure relief hole 1103 adjacent to the ear hook 200, respectively, arranging the sound outlet 1102 relatively far from the ear hook 200, and setting the length of the fifth shortest straight-line segment L12 to be less than or equal to 4 mm, the sound outlet 1102 maintains a relatively large distance from the second sound inlet 1101 and the pressure relief hole 1103, respectively. The setting effectively reduces the possibility that the sound transmitted outward from the sound outlet 1102 interferes with the second sound inlet 1101 and the pressure relief hole 1103. Additionally, the ear hook 200 may also provide a certain isolation between the second sound inlet 1101 and the pressure relief hole 1103, thereby effectively reducing interference between the pressure relief hole 1103 and the second sound inlet 1101, effectively improving the operational reliability of the earphone 1, and facilitating the improvement of the sound reception effect of the earphone 1.

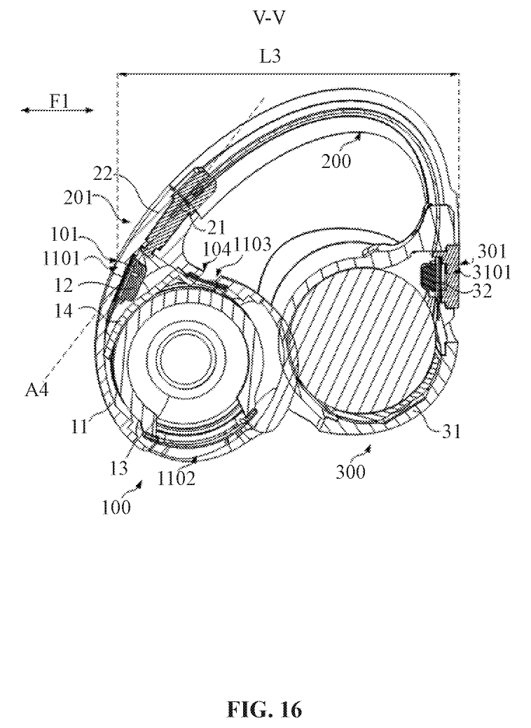

Optionally, as shown in FIG. 16, the ear hook 200 forms a connection region 201 on the second housing 11. The sound inlet end 101 of the second sound inlet 1101 and the sound outlet end 104 of the pressure relief hole 1103 are disposed on mutually opposite sides of the connection region 201. Alternatively, as shown in FIG. 6, the second housing 11 includes the main body 111 and a connection portion 112. The connection portion 112 connects the main body 111 and the ear hook 200. The sound inlet end 101 of the second sound inlet 1101 and the sound outlet end 104 of the pressure relief hole 1103 are disposed on mutually opposite sides of the connection portion 112.

By arranging the sound inlet end 101 of the second sound inlet 1101 and the sound outlet end 104 of the pressure relief hole 1103 on the opposite sides of the connection region 201 or the connection portion 112, the connection region 201 or the connection portion 112 is used to isolate the second sound inlet 1101 and the pressure relief hole 1103. The arrangement effectively reduces the possibility of mutual interference between the pressure relief hole 1103 and the second sound inlet 1101, effectively reduces the possibility of the sound transmitted by the pressure relief hole 1103 being introduced into the second sound inlet 1101, effectively reduces the possibility of phenomena such as sound leakage and echo, and facilitates the improvement of the sound reception effect of the earphone 1.

Optionally, as shown in FIG. 6, in the wearing state, the second sound inlet 1101 is disposed on a side of the connection region 201 or the connection portion 112 away from the auricle, and the pressure relief hole 1103 is disposed on another side of the connection region 201 or the connection portion 112 close to the auricle.

Disposing the second sound inlet 1101 on the side of the connection region 201 or the connection portion 112 away from the auricle avoids the auricle E17 of the user from blocking the second sound inlet 1101 in the wearing state, thereby affecting the sound introduction of the second sound inlet 1101, which facilitates the improvement of the sound reception effect of the earphone 1.

Optionally, as shown in FIG. 6, the connection portion 112 is arranged to be tapered in a direction away from the main body 111, to make the ear hook 200 and the outer surface of the main body 111 be smoothly connected, thereby improving the aesthetics of the earphone 1. The second microphone 12 is disposed inside the connection portion 112, and the second sound inlet 1101 is disposed on the connection portion 112, thereby making full use of the space of the connection portion 112, effectively improving the space utilization of the earphone 1, and making the structure of the earphone 1 more compact.

Optionally, as shown in FIG. 5, along the width direction F2 of the ear hook 200, the sound inlet end 101 of the second sound inlet 1101 and the sound outlet end 104 of the pressure relief hole 1103 are at least partially overlapped with the ear hook 200.

In some embodiments, the symmetry plane A1 is perpendicular to the width direction F2 of the ear hook 200. A straight-line perpendicular to the symmetry plane A1 and parallel to the width direction F2 of the ear hook 200 is used as the reference line A3. When the ear hook 200 is projected onto the reference line A3 along the symmetry plane A1, it has the first projection width S1. When the sound inlet end 101 of the second sound inlet 1101 is projected onto the reference line A3 along the symmetry plane A1, it has the third projection width S3. When the sound outlet end 104 of the pressure relief hole 1103 is projected onto the reference line A3 along the symmetry plane A1, it has a fourth projection width S4. The third projection width S3 and the fourth projection width S4 are at least partially overlapped with the first projection width S1, respectively, which facilitates the ear hook 200 to form a barrier between the sound inlet end 101 of the second sound inlet 1101 and the sound outlet end 104 of the pressure relief hole 1103, thereby effectively reducing the possibility of the sound transmitted by the pressure relief hole 1103 being introduced into the second sound inlet 1101, and facilitating the improvement of the sound reception effect of the earphone 1.

Optionally, a maximum dimension of an overlapping portion between the sound inlet end 101 of the second sound inlet 1101 and the ear hook 200 along the width direction F2 of the ear hook 200 is equal to a maximum dimension of the sound inlet end 101 of the second sound inlet 1101 along the width direction F2. As shown in FIG. 5, the maximum dimension of the sound inlet end 101 of the second sound inlet 1101 along the width direction F2 is a dimension of the third projection width S3. The maximum dimension of the overlapping portion between the sound inlet end 101 of the second sound inlet 1101 and the ear hook 200 along the width direction F2 of the ear hook 200 is a dimension of an overlapping portion between the third projection width S3 and the first projection width S1. That is, in the width direction F2 of the ear hook 200, the sound inlet end 101 of the second sound inlet 1101 completely overlaps with the ear hook 200, meaning that the entire third projection width S3 is covered by the first projection width S1.

Optionally, a ratio of a maximum dimension of an overlapping portion between the sound outlet end 104 of the pressure relief hole 1103 and the ear hook 200 along the width direction F2 of the ear hook 200 to a maximum dimension of the sound outlet end 104 of the pressure relief hole 1103 along the width direction F2 is greater than or equal to 90%. As shown in FIG. 5, the maximum dimension of the sound outlet end 104 of the pressure relief hole 1103 along the width direction F2 is a dimension of the fourth projection width S4. The maximum dimension of the overlapping portion between the sound outlet end 104 of the pressure relief hole 1103 and the ear hook 200 along the width direction F2 of the ear hook 200 is a dimension of an overlapping portion between the fourth projection width S4 and the first projection width S1. That is, a ratio of the dimension of the overlapping portion between the fourth projection width S4 and the first projection width S1 to the dimension of the fourth projection width S4 is greater than or equal to 90%. For example, when the first projection width S1 is completely covered by the fourth projection width S4, a ratio between the first projection width S1 and the fourth projection width S4 is greater than or equal to 90%.

In this way, the ear hook 200 may better form the barrier between the sound inlet end 101 of the second sound inlet 1101 and the sound outlet end 104 of the pressure relief hole 1103, which facilitates the improvement of the sound reception effect of the earphone 1.

Optionally, as shown in FIGS. 5 and 16, the ear hook 200 has the symmetry plane A1 extending along the length direction F1 of the ear hook 200. The ear hook 200 includes an elastic member 21 and an elastic coating layer 22 covering a periphery of the elastic member 21. At an end of the elastic member 21 close to the sound generating unit 100, the ear hook 200 further has a reference plane tangent to the elastic member 21 and perpendicular to the symmetry plane A1. The reference plane is referred to as a third reference plane A4. The sound inlet end 101 of the second sound inlet 1101 is disposed on one side of the third reference plane A4, and the sound outlet end 104 of the pressure relief hole 1103 is disposed on another side of the third reference plane A4. The elastic member 21 may be, for example, a titanium sheet. A material of the elastic coating layer 22 may be, for example, silicone, rubber, elastic resin, polyurethane material, polydimethylsiloxane, PVC, TPE, or other materials, to improve wearing comfort.

By arranging the sound inlet end 101 of the second sound inlet 1101 and the sound outlet end 104 of the pressure relief hole 1103 on the opposite sides of the third reference plane A4, respectively, a rigid housing on both sides of an extension surface of the elastic member 21 is used to further block the sound inlet end 101 of the second sound inlet 1101 and the sound outlet end 104 of the pressure relief hole 1103, thereby further improving the isolation effect between the sound inlet end 101 of the second sound inlet 1101 and the sound outlet end 104 of the pressure relief hole 1103, which facilitates the improvement of the sound reception effect of the earphone 1.

Optionally, as shown in FIG. 16, in the wearing state, the second sound inlet 1101 is disposed on a side of the third reference plane A4 away from the auricle E17, and the pressure relief hole 1103 is disposed on another side of the third reference plane A4 close to the auricle E17. The arrangement facilitates the second sound inlet 1101 to introduce the external sound, while the pressure relief hole 1103 has a different orientation from the second sound inlet 1101, and the rigid housing on both sides of the extension surface of the elastic member 21 isolates the pressure relief hole 1103 and the second sound inlet 1101, effectively reducing the possibility of mutual interference between the second sound inlet 1101 and the pressure relief hole 1103, which facilitates the improvement of the sound reception effect of the earphone 1.

Optionally, as shown in FIG. 9, on the outer wall surfaces of the second housing 11 and the ear hook 200, a shortest wall connection line exists between the hole edge of the sound inlet end 101 of the second sound inlet 1101 and the hole edge of the sound outlet end 104 of the pressure relief hole 1103. The shortest wall connection line is referred to as a second shortest wall connection line L11. The second shortest wall connection line L11 is specifically the shortest arc segment formed along the contour lines of the outer wall surfaces of the second housing 11 and the ear hook 200 between the hole edge of the sound inlet end 101 of the second sound inlet 1101 and the hole edge of the sound outlet end 104 of the pressure relief hole 1103.

An arc-to-chord ratio of the second shortest wall connection line L11 is set to be greater than or equal to 1.7. For example, the arc-to-chord ratio may be 1.7, 1.8, 1.9, 2.0, etc. Certainly, the arc-to-chord ratio may also be other values. By setting the arc-to-chord ratio of the second shortest wall connection line L11 to be greater than or equal to 1.7, the second housing 11 between the hole edge of the sound inlet end 101 of the second sound inlet 1101 and the hole edge of the sound outlet end 104 of the pressure relief hole 1103 is convex outward. The convex second housing 11 may further isolate the second sound inlet 1101 and the pressure relief hole 1103, effectively reducing the possibility of mutual interference between the second sound inlet 1101 and the pressure relief hole 1103, which facilitates the improvement of the sound reception effect of the earphone 1.

Optionally, as shown in FIG. 16, a partition plate 14 is disposed inside the sound generating unit 100. The second microphone 12 is disposed on a side of the partition plate 14 close to the ear hook 200, and the sound generating assembly 13 is disposed on a side of the partition plate 14 away from the ear hook 200. By setting the partition plate 14 to separate the second microphone 12 and the sound generating assembly 13, interference caused by the sound generating assembly 13 to the second microphone 12 is effectively reduced, which facilitates the improvement of the sound reception effect of the earphone 1.

The foregoing descriptions are merely embodiments of the present disclosure, and are not intended to limit the patent scope of the present disclosure. Equivalent structures or equivalent process transformations made based on the content of the present specification and the accompanying drawings, or direct or indirect applications in other related technical fields, are all similarly included within the patent protection scope of the present disclosure.

What is claimed is:

1. An earphone, comprising:
a sound generating unit, an abutment unit, and an ear hook, wherein
the ear hook connects the sound generating unit and the abutment unit;
in a wearing state, the sound generating unit and the abutment unit form a clamping state on two sides of an auricle, and the sound generating unit is located in a concha cavity;
the abutment unit comprises a first housing and a first microphone disposed in the first housing, the first microphone collecting a first sound through a first sound inlet on the first housing,
the first sound inlet having a sound inlet end located on an outer wall surface of the first housing;
the sound generating unit comprises a second housing, a second microphone disposed in the second housing, and a sound generating assembly, the sound generating assembly having at least one diaphragm, the sound generating assembly cooperating with the second housing to form a first acoustic cavity and a second acoustic cavity located on two sides of the diaphragm, a second sound inlet, a sound outlet and a pressure relief hole being disposed on the second housing, the second microphone collecting an external sound through the second sound inlet, a sound in the first acoustic cavity being transmitted to an ear canal of a user through the sound outlet, and a sound in the second acoustic cavity being transmitted to an outside of the second housing through the pressure relief hole;
the second sound inlet having a sound inlet end located on an outer wall surface of the second housing, the sound outlet having a first sound outlet end located on the outer wall surface of the second housing, and the ear hook having a symmetry plane along a length direction of the ear hook.

2. The earphone of claim 1, wherein a count of the first sound inlet is one, and the symmetry plane passes through the first sound inlet.

3. The earphone of claim 1, wherein the earphone further has a first reference plane located below the symmetry plane and parallel to the symmetry plane in the wearing state, a distance from the first reference plane to the symmetry plane being less than or equal to 5 mm;
the earphone is set to support a left ear wearing state and a right ear wearing state, a count of the first reference planes is two, and the two first reference planes are symmetrically disposed on two sides of the symmetry plane, wherein one of the two first reference planes is located below the symmetry plane when the earphone is in the left ear wearing state, and the other one of the two first reference planes is located below the symmetry plane when the earphone is in the right ear wearing state, and the sound inlet end of the first sound inlet is entirely located between the two first reference planes.

4. The earphone of claim 1, wherein when a user switches the earphone from a left ear wearing state to a right ear wearing state, or from the right ear wearing state to the left ear wearing state, a state of the earphone relative to its wearing ear remains unchanged, an orientation of the sound outlet and an orientation of the pressure relief hole on the wearing earphone relative to the ear canal remain unchanged.

5. The earphone of claim 1, wherein the earphone automatically identifies which ear it is worn on and adopts a corresponding control logic to change functions of the earphone when worn on different ears.

6. The earphone of claim 1, wherein a count of the first sound inlets is two, and the sound inlet ends of the two first sound inlets are symmetrically arranged relative to the symmetry plane.

7. The earphone of claim 1, wherein two first sound inlets are arranged on the first housing, each first microphone collects the first sound through a corresponding one of the two first sound inlets, the two first sound inlets respectively have the sound inlet ends located on the outer wall surface of the first housing, and the sound inlet ends of the two first sound inlets are arranged on two sides of the symmetry plane.

8. The earphone of claim 1, wherein a count of the first microphones is one, the first microphone collects the first sound via two first sound inlets, the sound inlet ends of the two first sound inlets are spaced apart from each other, and the two first sound inlets are in communication with each other.

9. The earphone of claim 1, wherein the symmetry plane passes through the sound inlet end of the second sound inlet and the first sound outlet end.

10. The earphone of claim 1, wherein in the wearing state, the sound inlet end of the second sound inlet is located on a side of the second housing away from the auricle and is closer to the ear hook than the first sound outlet end.

11. The earphone of claim 1, wherein the first sound outlet end and the sound inlet end of the second sound inlet are symmetrically arranged relative to the symmetry plane, respectively.

12. The earphone of claim 1, wherein the earphone further has a first reference plane located below the symmetry plane and parallel to the symmetry plane in the wearing state, a distance from the first reference plane to the symmetry plane being less than or equal to 5 mm, and the sound inlet end of the first sound inlet is entirely located on a side of the symmetry plane away from the first reference plane.

13. The earphone of claim 12, wherein a minimum linear distance from a hole edge of the sound inlet end of the first sound inlet to the symmetry plane is greater than or equal to 5 mm.

14. The earphone of claim 1, wherein the first sound outlet end is arranged in a strip shape, and on the symmetry plane, a hole edge of the first sound outlet end has a first endpoint and a second endpoint spaced apart along a length direction of the first sound outlet end, the first endpoint being closer to the sound inlet end of the second sound inlet than the second endpoint;
a first shortest straight-line segment is between a hole edge of the sound inlet end of the second sound inlet and a hole edge of the first sound outlet end,
the first shortest straight-line segment connects the first endpoint and a position point on the hole edge of the sound inlet end of the second sound inlet that is closest to the first endpoint, the earphone further has a third shortest straight-line segment connecting the first endpoint and the second endpoint, and an angle between the first shortest straight-line segment and the third shortest straight-line segment is less than or equal to 75 degrees.

15. The earphone of claim 1, wherein the abutment unit comprises two first microphones, the earphone further comprises a detection element and a processing circuit, the detection element is configured to detect a relative positional relationship between the two first microphones in the wearing state, and the processing circuit controls the two first microphones based on a detection result of the detection element.

16. The earphone of claim 15, wherein the processing circuit controls, based on the detection result of the detection element, one of the two first microphones that is relatively upper along a gravity direction to be in an operating state, and controls the other one that is relatively lower along the gravity direction to be in a non-operating state.

17. The earphone of claim 16, wherein the second microphone is configured to collect a second sound, and the processing circuit performs noise reduction processing based on the first sound collected by the first microphone in the operating state and the second sound collected by the second microphone.

18. The earphone of claim 16, further comprising a switching device, wherein the two first microphones are connected to a same audio port of the processing circuit via the switching device, and
the processing circuit controls, based on the detection result of the detection element, one of the two first microphones that is relatively upper along the gravity direction to be connected to the processing circuit, and disconnects the other one that is relatively lower along the gravity direction from the processing circuit, to put the other one in a non-operating state.

19. The earphone of claim 15, wherein the second microphone is configured to collect a second sound, the processing circuit performs a wind noise detection based on at least one of the first sound and the second sound, and controls, when a wind noise is detected to be greater than or equal to a preset threshold, one of the two first microphones that is relatively lower along a gravity direction to be in an operating state, and controls the second microphone to be in a non-operating state.

20. The earphone of claim 1, wherein the abutment unit comprises two first microphones, the earphone further comprises a processing circuit, and the processing circuit is configured to perform a wind noise detection based on the first sound, and control, when a wind noise is detected to be greater than or equal to a preset threshold, one of the two first microphones that collects the first sound with a smaller wind noise to be in an operating state, and control the other one of the two first microphones to be in a non-operating state.
